(19) United States
(12) Patent Application Publication
(10) Pub. No.: US 2011/0265435 A1
(43) Pub. Date: Nov. 3, 2011

(54) Fan Filter Device

(75) Inventor: Erich Peteln, Blumau (AT)

(73) Assignee: Dexwet USA, LLC

(21) Appl. No.: 13/098,098

(22) Filed: Apr. 29, 2011

Related U.S. Application Data
(60) Provisional application No. 61/329,621, filed on Apr. 30, 2010.

(51) Int. Cl. B01D 46/10

(52) U.S. Cl. 55/471

(57) ABSTRACT

A fan filter device with one or more fan blades substantially comprising a filter media coated or impregnated with a fluid for removing particulates, such as dust and other pollution, from airflow in a wide variety of environments. The fluid has evaporation and viscosity characteristics suitable for maintaining the filter media in a wet condition at the desired speed and temperature of operation.

The present application claims priority to and the benefit of the filing date of U.S. Provisional Patent Application Ser. No. 61/329,621 filed Apr. 30, 2010, which is incorporated herein by reference.

### FIELD OF THE INVENTION

The present invention pertains to the filtering of air by fan rotors or fan blades constructed air filtering material to eliminate or reduce pollution from airflow.

### BACKGROUND OF THE INVENTION

Air pollution can be a detriment to both persons and machines. Polluted air negatively affects health, and it can clog or overheat machines and electronics. Improved systems are needed to filter out air pollutants.

### SUMMARY OF THE INVENTION

To answer this need, in one embodiment of the invention a fan blade comprises an air filter material to remove pollutants from the airflow. In embodiments, the air filter material may be coated or impregnated with a moistening substance, such as fluid compositions, to provide improved filtering results, including binding particulates, such as fine and ultrafine dust particles, to a fan blade individually or together with other fan rotor components made of filter material.

In certain embodiments, fan blades comprised of filter material may be individually replaced as part of the fan rotor. In other embodiments, a combination of fan blades together with one or more of the hub and other fan rotor components coupled to such blades may all be constructed of filter material.

In embodiments of the invention, the filter material components of the fan may be removed for cleaning or may be disposable and replaceable. The filter material may also be recyclable.

### BRIEF DESCRIPTION OF THE DRAWINGS

The particular features and advantages of the invention as well as other objects will become apparent from the following description taken in connection with the following drawings in which:

FIG. 1 is a front perspective view of one preferred embodiment of the fan filter device of the present invention.

FIG. 2 is a rear perspective view of the fan filter device of FIG. 1.

FIG. 3 is a front perspective view of an alternate preferred embodiment of the fan filter device of the present invention.

### DESCRIPTION OF THE INVENTION

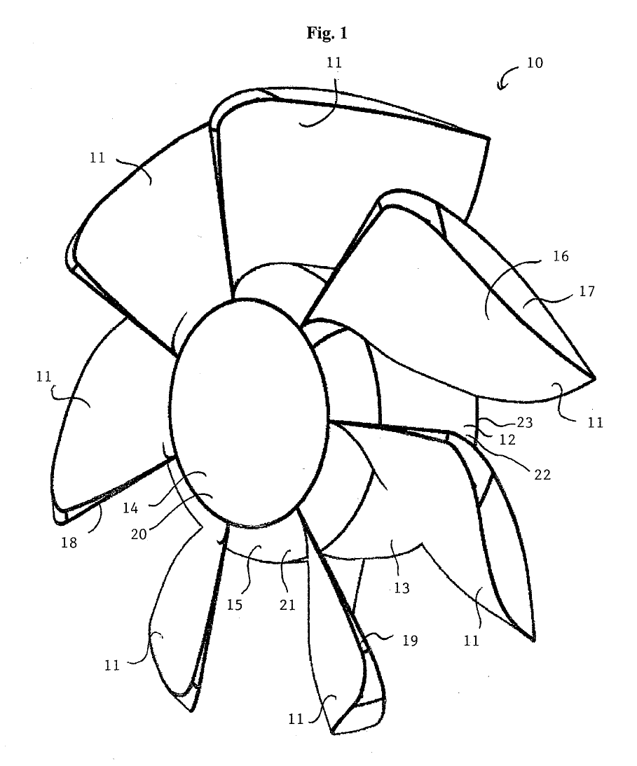

As illustrated in FIG. 1, the device of the present invention is directed to a fan filter device or fan 10 having a plurality of fan blades 11 spaced about the periphery of the rotor body 12. In the present invention, one or more of said plurality of fan blades 11 substantially comprise or are substantially made of a porous filter material or filter media that filters pollution (particulates and the like) from airflow. Alternately, one or more selected components of the rotor body 12, such as hub 23, peripheral side wall 13, top 14, or hub surfaces 15 connecting side wall 13 and top 14, may also be substantially made of filter media that filters pollution from airflow.

Airflow may include intake, exhaust and circulating air. A fan filter apparatus 10 of the present invention may be sized to large or small environments, ranging by non-limiting examples to a fan 10 that filters air to/from a room or building to a fan 10 that filters air in small electronics (not shown) such as computing devices and office machines.

In one embodiment, a fan device 10 of the present invention includes fan blades 11 (or, including the fan blades 11, one or more components 11, 12, 13, 14, 15, 23 of the rotor body 12, or the entire fan 10) made of a filter medium substantially comprising polyethylene. A polyethylene having PE, XM-1834, Hydrophop, pore size from 180 to 320 μm, pore volume of less than 35% has been found suitable for use in the present invention. In one preferred embodiment, such polyethylene is manufactured by Porex Technologies GmbH (Aachen, Germany).

The filter media of the fan blades 11, and, as desired, select rotor body 12 components 13, 14, 15, 23, may be “wet” to provide rotating “wet” filtering of the airflow. In “wet” fan filtering, one or more of the surfaces 16, 17, 18, 19 of the blades 11 (or select surfaces 20, 21, 22 of rotor body 12 components 11, 12, 13, 14, 15, 23, are maintained in wet condition.

A fluid for maintaining the filter media in a wet condition may be coated or impregnated in the filter media to contact, bind and filter particulates and other pollution. Preferably such fluid keeps the filter media of the fan 10 wet for longer periods of time, such as not drying out for several months or years, even during substantially continuous use throughout such period. The aforementioned polyethylene filter media construction has been found preferable for maintaining the fan blades 11 in wet condition.

In one embodiment, a preferred fluid for maintaining the filter media in a wet condition comprises a silicon liquid, such as XIAMETER® PMX-200 Silicone Fluid, from 5,000 to 60,000 cSt (manufactured by Dow Corning Corporation (Midland, Mich.)). However, depending on the speed of the circulating blades 11 (RPMs) and/or temperature of the airflow environment, other liquids with different evaporation and viscosity characteristics may be more suitable to a particular filtering application.

The viscosity of the fluid is important to avoid the fluid from draining from the filter media of the fan blades 11 (and/or other selected components 12, 13, 14, 15, 23 of the fan rotor body 12) as a result of the speed of rotation of the fan blades 11 (and/or other rotor body 12 components 13, 14, 15, 23).

In other embodiments, special-purpose liquid chemicals for reacting with gases or other compounds in an airflow environment may be provided on the filter media of the fan blades 11 and any applicable selected rotor body 12 components 13, 14, 15, 23. Further, scented liquid chemicals may be provided on fan blades 11 and applicable selected rotor body 12 components 13, 14, 15, 23 that comprise filter material.

The lifetime of the fan filter 10 depends on the amount of pollutants in the air and the volume of particles which build up on the rotor body 12, other components 13, 14, 15, 23, and the blades 11. As the fan blades 11 (and selected rotor body 12 components 13, 14, 15, 23, if applicable) constructed of filter media collect dust and pollution, in certain embodiments of the invention, cleaning, recycling or replacement may be necessary. Accordingly, the fan blades 11 (including with a hub 23 and/or other selected rotor body 12 components) are removable for cleaning and re-application of fluid in alternate embodiments of the invention, such as fan blades 11 being releasably affixed to the hub 23.

In another embodiment, the filter media components 11, 12, 13, 14, 15,23 of the fan 10, or the entire fan 10 itself, may be disposable or recyclable. In some embodiments, the fan 10, fan blades 11 and/or other fan components 12, 13, 14, 15, 23 comprised of filter media may be re-usable by washing with water or other chemical solvents, drying as applicable and applying one or more fluids for re-use of the fan blades 11 and components 12, 13, 14, 15, 23 in the same or other fan applications.

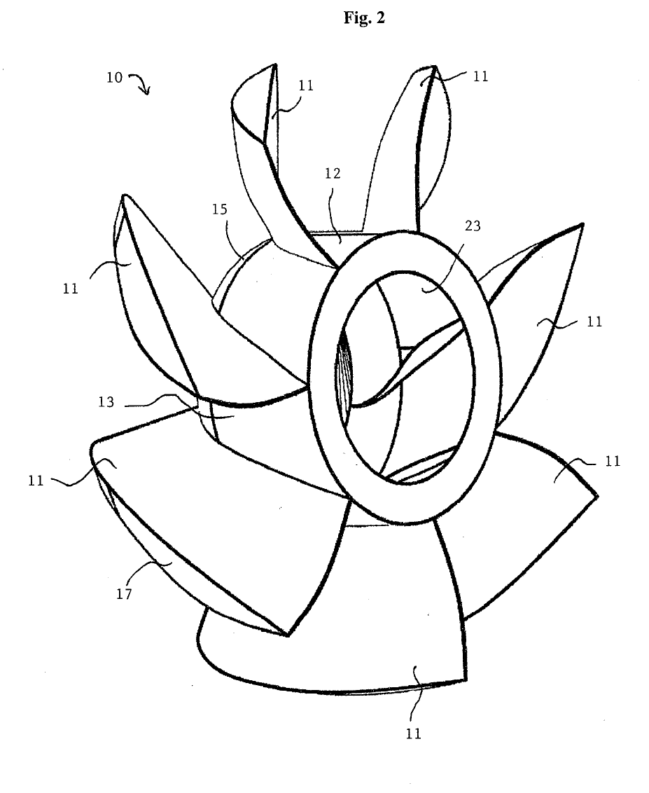

FIG. 2 illustrates a rear perspective view of a preferred embodiment of the fan 10 of the present invention. Hub 23 of rotor body 12 may be adapted to accommodate any conventional means for rotating fan 10 as is well known in the art.

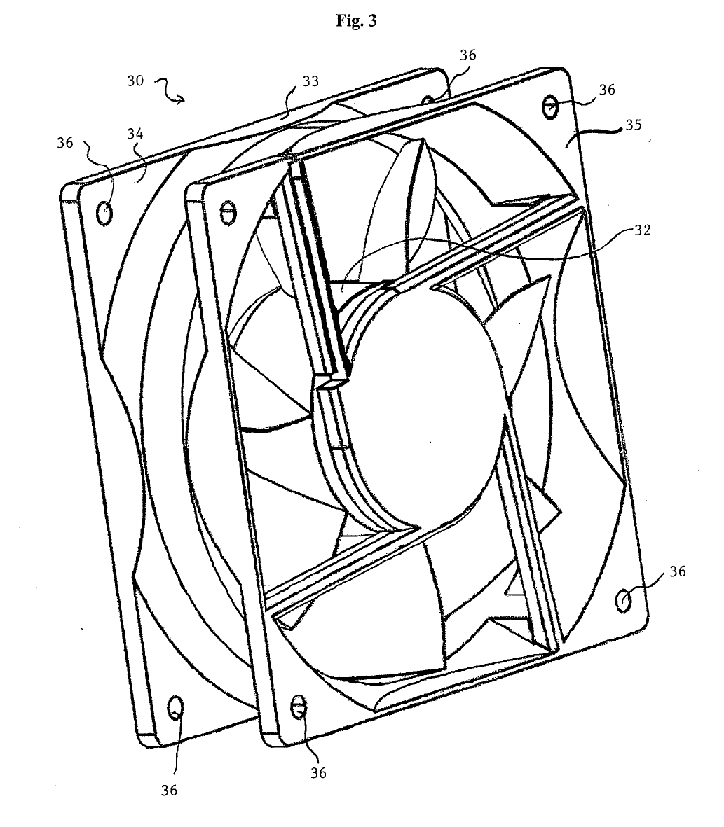

FIG. 3 illustrates a perspective view of an embodiment of the fan filter device 30 of the present invention suitable for use in connection with small electronics, such as computing devices or office machines (not shown). Fan rotor body 32 of fan filter device 30 is carried by a housing 33 comprising one or more plates 34, 35, each such plate 34, 35 further comprising means for fastening, such as one or more screw holes 36, or other conventional fastening means, such as being sized to slide within a preformed slot (not shown), or the like.

In another embodiment, one or both plates 34, 35 are substantially constructed of filter media which may also be “wet” in accordance with the present invention.

While the invention has been described with reference to the structures and methods disclosed, it is not confined to the details set forth, but is intended to cover such modifications or changes as may fall within the scope of the following claims.

I claim:

1. A fan comprising one or more fan blades, said fan blades comprising a filter media, said filter media having a fluid at the surface of the fan blade.

2. The fan of claim 1 wherein the filter media is porous.

3. The fan of claim 1 wherein the filter media substantially comprises polyethylene.

4. The fan of claim 2 wherein the filter media substantially comprises polyethylene.

5. The fan of claim 1 wherein the fluid comprises a silicone fluid.

6. The fan of claim 2 wherein the fluid comprises a silicone fluid.

7. The fan of claim 3 wherein the fluid comprises a silicone fluid.

8. The fan of claim 4 wherein the fluid comprises a silicone fluid.

9. The fan of claim 1 wherein said fan blades are coupled to one or more fan rotor body components substantially comprising filter media.

10. The fan of claim 3 wherein said fan blades are coupled to one or more fan rotor body components substantially comprising filter media.

11. The fan of claim 5 wherein said fan blades are coupled to one or more fan rotor body components substantially comprising filter media.

12. The fan of claim 1 wherein said fan blades are removable.

13. The fan of claim 3 wherein said fan blades are removable.

14. The fan of claim 5 wherein said fan blades are removable.

15. The fan of claim 9 wherein said fan blades are removable.

16. The fan of claim 1 wherein said fan blades are at least one of recyclable, washable, disposable and replaceable.

17. The fan of claim 5 wherein said fan blades are at least one of recyclable, washable, disposable and replaceable.

18. The fan of claim 12 wherein said fan blades are at least one of recyclable, washable, disposable and replaceable.

19. The fan of claim 9 wherein said fan rotor body components are at least one of recyclable, washable, disposable and replaceable.

20. The fan of claim 10 wherein said fan rotor body components are at least one of recyclable, washable, disposable and replaceable.
